(19) United States
(12) Patent Application Publication
(10) Pub. No.: US 2014/0008930 A1
(43) Pub. Date: Jan. 9, 2014

(54) Reacher

(71) Applicant: The Helping Hand Company (Ledbury) Limited, Ledbury (GB)

(72) Inventor: Gavin JAMES, Ledbury (GB)

(21) Appl. No.: 13/935,561

(22) Filed: Jul. 5, 2013

(30) Foreign Application Priority Data
Jul. 5, 2012 (GB) 1211960.8

(51) Int. Cl. B25J 1/04

(52) U.S. Cl. CPC B25J 1/04
USPC 294/198

(57) ABSTRACT

A hand-held reacher for gripping an object comprises a handle portion, a jaw portion, and a shaft extending between the handle portion and the jaw portion. The jaw portion has jaws moveable between an open position and a closed position. The handle portion has a manually-operable trigger for moving the jaws between the open and closed position, and a locking member for releasably locking the jaws in a closed or partially closed position.

The present invention relates to a reacher and particularly to a reacher for gripping or picking up an object, for example, to assist a person in picking up an object placed on the ground without bending down,

### BACKGROUND TO INVENTION

Hand-held devices for gripping, such as reachers, are commonly used for assisting a user in gripping or picking up items at a distance from where they are positioned. Most generally, reachers comprise a handle portion, a jaw portion having a plurality of jaws and a support extending therebetween. Typically a cable, push-rod linkage, or the like, moves the jaws between an open position and a closed position on operation of a trigger.

Known devices require the user to hold the trigger or similar in a closed position, to hold the jaws in a closed or gripping position, for example when moving an item, once gripped. This can be problematic, for example, when the user has arthritis or other such ailment that may make subsequent gripping of the jaws for a sustained period of time difficult.

It is an object of this invention to provide a reacher which reduces or substantially obviates the above mentioned problems.

### STATEMENT OF INVENTION

According to the present invention, there is provided a hand-held reacher for gripping an object, the hand-held reacher comprising: a handle portion; a jaw portion; and a shaft extending between the handle portion and the jaw portion, the jaw portion having jaws moveable between an open position and a closed position, and the handle portion having a manually-operable trigger for moving the jaws between the open and closed position, and a locking member for releasably locking the jaws in a closed or partially closed position.

A hand-held reacher provided with a locking member operated by a manually-operable trigger is advantageous in allowing for the jaws to be held or locked in a closed or partially closed position, once an object is gripped or partially gripped. A lockable grip mechanism is particularly advantageous for users who may suffer from arthritis or other ailments, where depressing a trigger for a sustained period of time may cause discomfort or pain.

The hand-held reacher may be provided with a trigger that is pivoted to the handle portion. The trigger may be pivoted about a first pivotal axis.

The hand-held reacher may be provided with any suitable means for connecting the trigger to the jaw portion. In one arrangement the connecting means is a push rod. In a preferred arrangement the connecting means is a cable which extends between the trigger and jaw portion. The cable may be provided with a crimped or otherwise enlarged end for inserting into a cable guide in the trigger. The cable guide is conveniently shaped to receive a cable. It is preferred that the cable guide is curved for smoothly guiding the cable into the trigger.

The jaw portion may be provided with a spring for returning the jaws to an open position, that is when the jaws are substantially spaced apart from each other. When actuated, the jaws move to a closed position, that is when the jaws are in a substantially gripping position around an object or when the jaws are in contact with each other.

The locking member may be a locking pawl. In a preferred configuration, the locking pawl is pivoted to the handle portion about a second pivotal axis. In this configuration the first and second axes are spaced apart from each other and when operated, the locking pawl follows an arcuate path. The locking pawl is a generally elongate member having an arced profile at its distal end, that is the end furthest from the second pivotal axis.

The locking pawl may further be provided with teeth which engage with corresponding teeth on the trigger, in the manner of a ratchet. Providing teeth on both a surface of the trigger and the distal edge of the pawl provides for the temporary locking of the pawl against the trigger, when the device is in use. The teeth are preferably provided and extend along the arced face of the locking pawl. The locking pawl may further comprise a cavity and the cavity may comprise an internal surface forming a cam surface.

The trigger and locking pawl may move independently of one another.

The reacher may further be provided with a locking actuator. The locking actuator is pivoted to the handle portion about the first pivotal axis. The locking actuator generally comprises a main body and an arm fixed to the main body at a right angle. The arm may have a cam surface for contacting the cam surface on the locking pawl. This configuration provides for the control of the pawl, relative to the position of the trigger. The arm is generally elongate and has a curved distal end, that is the end furthest from the main body of the locking member. The curved profile is shaped to provide a curved path for guiding the cam surface of the locking pawl. It is envisaged that the cam surface of the arm passes fully through the cavity of the locking pawl and is in constant contact with this surface. Conveniently, this configuration provides for the control and guiding of the pawl, relative to the position of the trigger. As such, the pawl may be moved into contact with the trigger when the trigger is operated. This provides for the gradual locking of the pawl against the trigger in the manner of a ratchet, providing for the gradual and controlled locking of the jaws as they close.

The locking member may be provided with a resilient arm. The resilient arm may contact a surface of the trigger. In a preferred configuration, the resilient arm contacts a profiled surface of the trigger and as such, the trigger may be profiled to have a slot cut out of it for receiving the locking actuator and more specifically, the resilient arm. The resilient arm is conveniently profiled as part of or within the body of the locking actuator and is spaced apart from the body of the locking member. This offset position provides for the flexure and translation of the resilient arm, when contact is made between the locking member and the trigger. The resilient arm may bias the locking actuator away from the surface of the trigger. The resilient arm may further control the relative position of the locking actuator relative to the trigger, and further, the position of the pawl relative to the trigger. The resilient arm provides a physical stop for limiting the degree of movement of the locking actuator.

The trigger and the locking actuator may move independently of one another. This allows for the operation of the trigger, when locking of the jaws is not required.

The locking actuator may be housed at least partially within the trigger. This configuration is advantageous in that the locking actuator is positioned centrally of the trigger, at its upper end. The locking actuator may further have a trigger portion. The trigger portion may provide for the simultaneous operation of the locking actuator with the trigger. Therefore, selective operation of the trigger independent of the locking actuator can be achieved. This provides for the selective operation of the device between unlocked and locked positions.

In a preferred arrangement, and when locking of the jaws is required, the trigger and locking actuator move simultaneously to engage the locking pawl with the trigger. The simultaneous operation of the trigger and locking actuator results in the rotation of the pawl, the teeth of which engage with corresponding teeth on the trigger. Contact between the teeth locks the position of the trigger, which in turn locks the jaws in their associated position.

As described above, the trigger and the locking actuator may move independently of one another. In this respect, the trigger and the trigger portion of the locking actuator may also move independently of one another. This configuration is particularly advantageous when unlocking of the jaws is required. When the reacher has its jaws in a locked or gripping position, unlocking of the jaws may be achieved by operating the trigger, independently of the trigger portion of the locking actuator. Operation of the trigger independently of the trigger portion of the locking actuator, when the jaws are in the gripping position, results in rotation of the trigger about the first pivotal axis, in a downwardly direction. As the trigger is operated, it moves towards the handle portion and away from the pawl, which remains in a constant position, the teeth are slowly disengaged until the locking pawl is free of the trigger. Once the locking pawl has become fully disengaged from the trigger, the trigger may be returned to the rest position, thus with the jaws returning to an open position. Accordingly, the independent and simultaneous operation of the trigger and trigger portion of the locking actuator provides for the locking and unlocking of the jaws.

The handle portion may be provided with a grip. The grip may be provided with a gel portion extending at least partially around the grip. A handle portion comprising a grip and a grip comprising a gel is advantageous in providing cushioning to a users' hand.

The jaw portion may be adjustably attached to the shaft. The jaw portion may also be rotatable about the shaft. A jaw portion that is both releasably attached and rotatable about the shaft allows for the repositioning of the jaw portion in relation to the shaft. In one configuration the jaw portion may be translated along the shaft and then rotated about the shaft, by 90 degrees, in either direction. The jaw portion may be translated along and rotated about the shaft, whilst still connected to the trigger, by the cable. Rotation of the jaw portion about the shaft allows for the gripping of objects, without the need of the user to rotate their wrist.

### BRIEF DESCRIPTION OF THE DRAWINGS

For a better understanding of the present invention, and to show more clearly how it may be carried into effect, reference will now be made, by way of example only, to the accompanying drawings, in which:

FIG. 1 shows a cross-sectional view of a reacher according to the invention in a rest or open position;

FIG. 2 shows a cross-sectional view of a reacher according to the invention with the jaws positioned to grip an object;

FIG. 3 shows a cross-sectional view of a reacher according to the invention with the jaws in a gripped position, and with the locking member engaged; and

FIG. 4 shows an exploded view of the handle portion of a reacher as shown in FIGS. 1 to 3.

### DESCRIPTION OF PREFERRED EMBODIMENTS

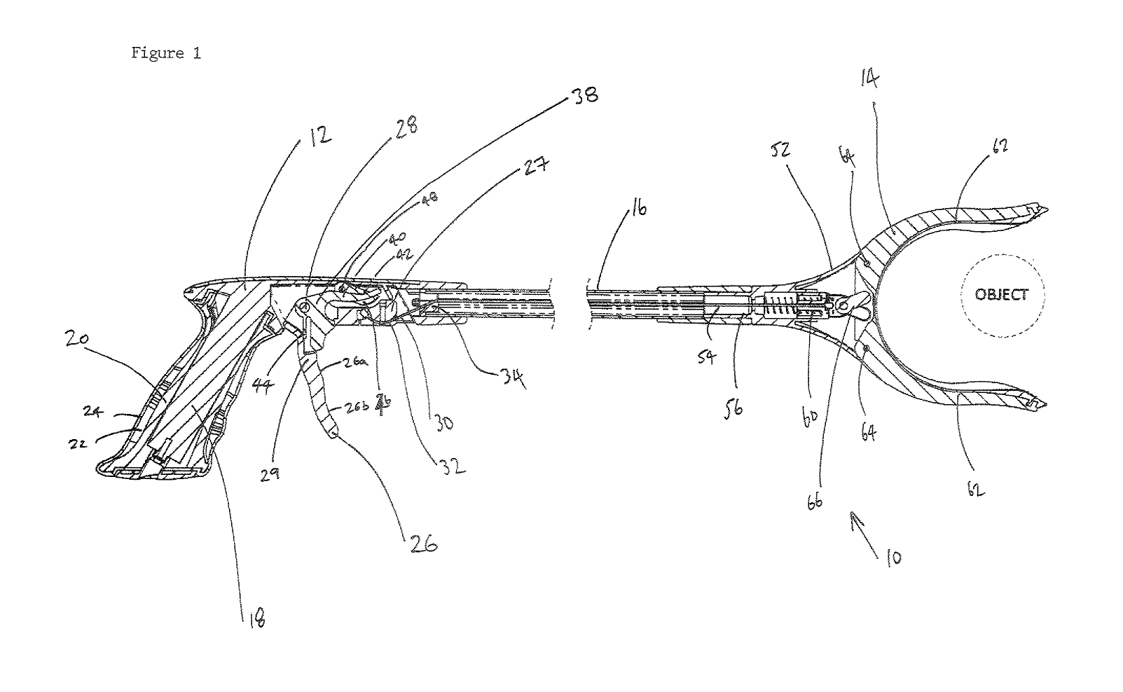

Referring firstly to FIGS. 1 to 3, a reacher is indicated generally at 10. The reacher 10 is shown in a rest position in FIG. 1 and comprises a handle portion 12, a jaw portion 14 and a shaft 16 extending between the handle portion 12 and the jaw portion 14.

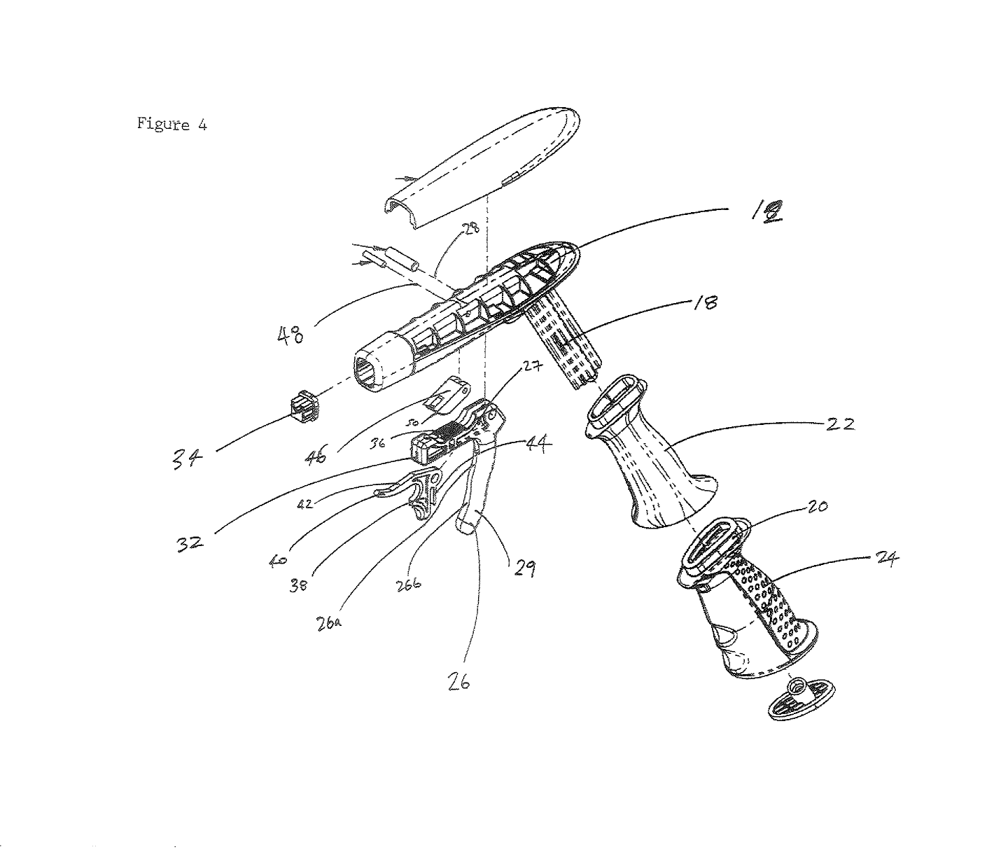

The handle portion 12 is provided with a handle shaft 18 and a grip portion 20. The grip portion 20 has a grip core 22 and a skin 24 (shown more clearly in FIG. 4). The skin 24 covers at least a portion of the grip portion 20. In a preferred arrangement, the skin 24 completely covers the grip portion 20. The skin 24 may be a single layer of a resilient material. Alternatively the skin 24 may be provided with an outer layer of a resilient material and is filled with a gel, to provide cushioning. The skin is preferably ergonomically shaped to receive a gripped hand and may comprise a number of rises and depressions to accommodate a users' fingers.

The grip portion 20 is fixed to the handle portion 12 by sliding the grip portion 20 over the handle shaft 18 and then securing in place by suitable means, for example, a cap and threaded fastener.

The handle portion 12 further comprises a trigger 26, which is pivoted to the handle portion 12 at first pivotal axis 28. The trigger 26 can be squeezed by hand to move it towards the handle portion 12. The trigger 26 is returned by way of a spring in the jaw portion 14. The trigger 26 includes a first arm 27, which extends substantially in line with the shaft 16 of the reacher, and a second arm 29, which extends downwardly from the pivot point at the end of the first arm. The second arm 29 is disposed in front of the handle shaft 18 and grip portion 20. The second arm 29 is shaped with two depressions 26a and 26b in its forward face for receiving a users' fingers. A cable 30 connects the first arm 27 to the jaw portion 14. A cable guide 32 is provided within the first arm 27 for receiving one end of the cable 32. When the trigger 26 is operated, the cable guide 32 moves downwardly in an are relative to the handle portion 12, which in turn pulls the cable 30 towards the handle to operate the jaw mechanism in the jaw portion 14. The handle portion 12 is also provided with cable guide plug 34 for directing the cable 30 into the cable guide 32 of the trigger 26, ensuring smooth operation of the reacher.

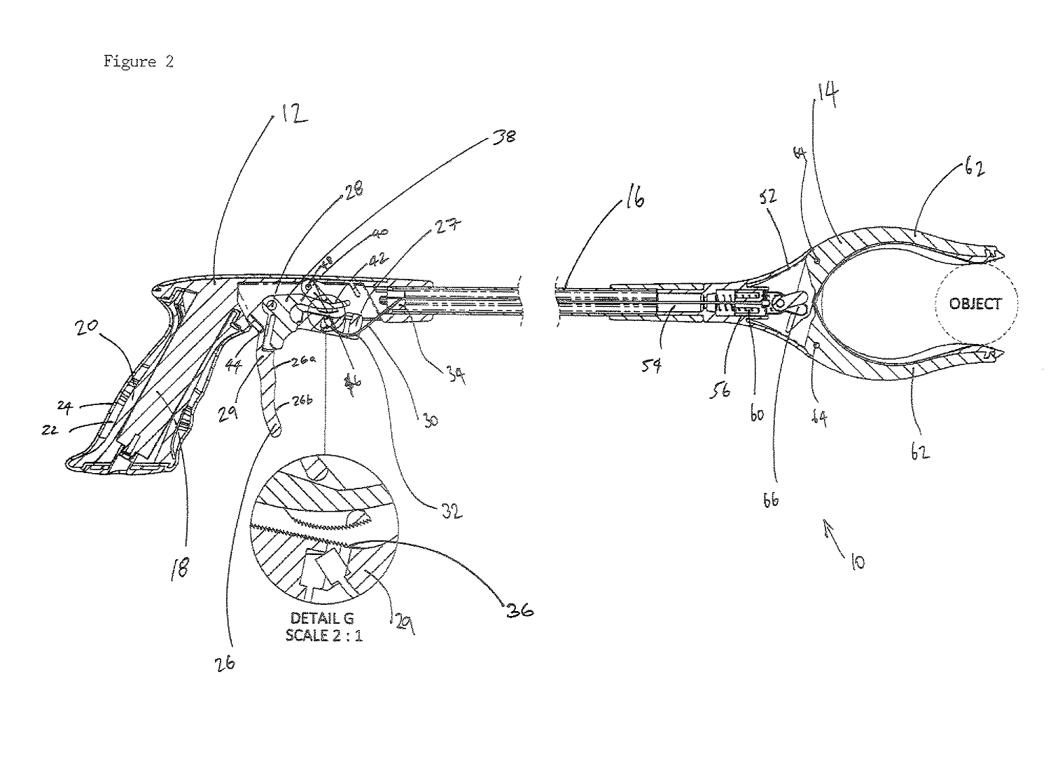

The trigger 26 has teeth 36, which extend at least partially along an upper surface of a recess provided in the first arm 27. The teeth 36 of the trigger 26 are shown clearly in FIG. 2.

The handle portion 12 further comprises a locking actuator 38, which is pivoted to the handle portion 12 at the first pivotal axis 28 and housed substantially within a slot through the trigger 26. This configuration provides the selective simultaneous movement of both the trigger 26 and locking actuator 38. The locking actuator 38 has arm 40 having cam surface 42, which is disposed substantially parallel to the first arm 29 of the trigger 26. The locking actuator 38 also comprises a resilient arm 44, which contacts a recess provided in the forward face of the second arm 29 of the trigger 26.

A pawl 46 is pivoted to the handle portion 12 at a second pivotal axis 48. The first and second pivotal axes 28, 48 are offset and lie parallel with each other, and the trigger 26, in combination with the locking actuator 38 and pawl 46 rotate in separate arcuate paths, when the trigger 26 is depressed. The pawl 46 has a cavity having an internal surface which contacts with the cam surface 42 of the arm 40. The pawl 46 is moveable by the arm 40, between first and second positions, as the arm 40 moves within the cavity of the pawl 46. The pawl has an arced surface at its distal end from the second pivotal axis 48. The arced surface has teeth 50 which engage with corresponding teeth 36 on the trigger 26. The teeth 50 of the pawl 46 are shown clearly in FIG. 2.

The jaw portion 14 comprises body 52, cable guide 54 and spring housing 56. A spring 58 is provided within the spring housing 56 and contacts stop 60. The jaw portion 14 further comprises jaws 62, which are pivoted to the body 52 about pivotal axes 64. The jaw mechanism 66 is connected to a respective jaw 62, which when pulled by the cable 30 towards the handle portion 12 results in the rotation of the jaws 62 about pivotal axes 64.

As described above, the reacher 10 is shown in a rest position in FIG. 1. Operation of the reacher 10 is achieved by a first operation of the trigger 26, by a user gripping the handle portion 12 and squeezing the trigger 26 such that it is rotated in a downwardly direction towards the handle portion 12. As the trigger 26 is rotated, the cable guide 32 moves relative to the rotation of the trigger 26, which in turn pulls cable 30 towards the handle portion 12. This in turn pulls the jaw mechanism 66 against the stop 60, which compresses the spring 58 within the spring housing 56. Translation of the jaw mechanism 66 in this manner results in the operation of the jaws 62, moving the jaws 62 into a gripping position.

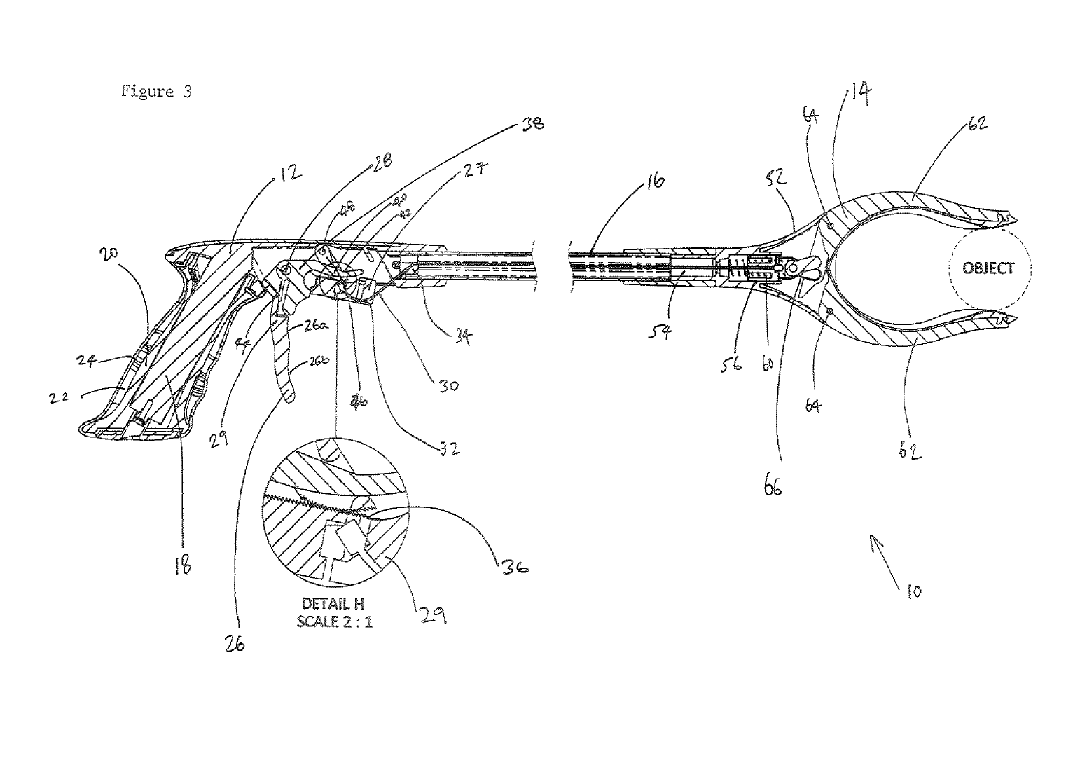

When the reacher 10 is to be locked, simultaneous operation of the trigger 26 and the locking actuator 38 is required. In this manner, the trigger 26 and locking actuator 38 are first moved from the rest position in a generally downwardly direction towards the handle portion 12. As the locking actuator 38 moves in combination with the trigger 26, the arm 40 moves relative to the trigger 26 too, and contact between the cam surface 42 of the arm 40 and the internal surface of the pawl 46 rotates the pawl about second pivotal axis 48. Further simultaneous operation of the trigger 26 and locking actuator 38 further rotates the pawl 46 about second pivotal axis 48 until the teeth 50 of the pawl 46 contact the teeth 36 of the trigger. Once sufficient teeth are in contact, the pawl 46 will be held in position against the trigger 26. Throughout this operation, the jaws 62 are slowly rotated towards a gripping position, until they are locked in position by contact between the teeth 36, 50 of the pawl 46 and the trigger 26, in the manner of a ratchet. The reacher 10 is shown in a fully gripped position in FIG. 3, where it can be seen that the teeth 36 and 50 are in contact.

Unlocking of the reacher 10 may be achieved by operating the trigger 26 independently of the locking actuator 38. As described above, further rotation of the trigger 26 when it is in a locked position results in the rotation of the trigger 26 in a downwardly direction towards the handle portion 12. This operation moves the teeth 36 on the trigger 26 away from the teeth 50 on the pawl 46, thus disengaging the teeth from each other. Once the teeth 36 and 50 have been disengaged, rotation of the trigger 26 results in rotation of the pawl 46 about the first pivotal axis 28 towards the rest position. Respective opening of the jaws 62 is achieved through this motion.

The trigger, locking actuator and pawl provide a simple ratchet locking system, which is easy to lock and release, by squeezing the trigger and locking actuator. It obviates the need to hold the trigger when the reacher is gripping an object and the release mechanism does not require operation of a catch or other element requiring particularly dexterity.

1. A hand-held reacher for gripping an object, the hand-held reacher comprising:
a handle portion;
a jaw portion; and
a shaft extending between the handle portion and the jaw portion, the jaw portion having jaws moveable between an open position and a closed position, and the handle portion having a manually-operable trigger for moving the jaws between the open and closed position, and a locking member for releasably locking the jaws in a closed or partially closed position.

2. A hand-held reacher as claimed in claim 1, in which the trigger is pivoted to the handle portion about a first pivotal axis.

3. A hand-held reacher as claimed in claim 1, in which a cable connects the trigger to the jaws.

4. A hand-held reacher as claimed in claim 1, in which a spring is provided in the jaw portion for biasing the jaws to the open position.

5. A hand-held reacher as claimed in claim 4, in which the trigger is returned to a return position when the jaws are moved to the open position by the spring.

6. A hand-held reacher as claimed in claim 2, in which the locking member is a locking pawl pivoted to the handle portion about a second pivotal axis.

7. A hand-held reacher as claimed in claim 6, in which the locking pawl is provided with teeth which engage with corresponding teeth on the trigger, to retain the trigger in an operative position and the jaws in a closed or partially closed position.

8. A hand-held reacher as claimed in claim 6, in which the trigger and locking pawl can move independently of one another.

9. A hand-held reacher as claimed in claim 6, in which a locking actuator is pivoted to the handle portion about the first pivotal axis.

10. A hand-held reacher as claimed in claim 9, in which the locking actuator has a cam surface which contacts a corresponding cam surface on the pawl.

11. A hand-held reacher as claimed in claim 10, in which the cam surface of the locking actuator controls the position of the pawl during locking.

12. A hand-held reacher as claimed in claim 9, in which the locking actuator has a resilient arm which engages a surface of the trigger.

13. A hand-held reacher as claimed in claim 12, in which the resilient arm biases the locking member away from the surface of the trigger.

14. A hand-held reacher as claimed in claim 12, in which the resilient arm controls the position of the locking actuator relative to the trigger, and hence the position of the pawl relative to the trigger.

15. A hand-held reacher as claimed in claim 9, in which the trigger and locking actuator move independently of each other.

16. A hand-held reacher as claimed in claim 9, in which the locking actuator is housed at least partially within the trigger.

17. A hand-held reacher as claimed in claim 9, in which the locking actuator has a trigger portion for simultaneous operation with the trigger.

18. A hand-held reacher as claimed in claim 17, in which the trigger and locking actuator move simultaneously to engage the locking pawl with the trigger.

19. A hand-held reacher as claimed in claim 17, in which the trigger can be operated independently of the locking actuator to release the locking member from the trigger and unlock the jaws.

20. A hand-held reacher fir gripping an object, the hand-held reacher comprising:
a handle portion;
a jaw portion; and
a shaft extending between the handle portion and the jaw portion,
the jaw portion having jaws movable between an open position and a closed position, and
the handle portion having a manually-operable trigger pivotally mounted to the handle portion about a first pivotal axis for moving the jaws between the open and closed position, a locking pawl pivotally mounted to the handle about a second pivotal axis for releasably locking the jaws in a closed or partially closed position, and a locking actuator for moving the locking pawl, the locking actuator being pivoted to the handle portion about the first pivotal axis and being housed at least partially within the trigger, the trigger and locking pawl being movable independently of one another and the trigger and locking actuator being movable independently of one another.
